(19) United States
(12) Patent Application Publication
(10) Pub. No.: US 2022/0147699 A1
(43) Pub. Date: May 12, 2022

(54) IMAGE INFORMATION PROCESSING APPARATUS, ELECTRONIC EQUIPMENT, AND IMAGE INFORMATION PROCESSING PROGRAM

(71) Applicant: Konica Minolta Inc., Tokyo (JP)

(72) Inventor: TOSHIMI SHINCHI, Saitama-shi (JP)

(21) Appl. No.: 17/495,861

(22) Filed: Oct. 7, 2021

(30) Foreign Application Priority Data
Nov. 6, 2020 (JP) 2020-185839

(51) Int. Cl. G06F 40/169

(52) U.S. Cl. CPC G06F 40/169

(57) ABSTRACT

An image information processing apparatus includes: a hardware processor that: specifies, based on image information of an image captured by an imaging part, a document region in which a document that is visually recognizable recorded matter is arranged, the document region being a region included in the image; acquires an annotation corresponding to the document; and causes the annotation to be displayed in a region corresponding to a non-document region in a display region of a display, the non-document region being a region other than the document region in the image.

The entire disclosure of Japanese patent Application No. 2020-185839, filed on Nov. 6, 2020, is incorporated herein by reference in its entirety.

### BACKGROUND

### Technological Field

The present invention relates to an image information processing apparatus, electronic equipment, and an image information processing program.

### Description of the Related art

In recent years, a method of acquiring an annotation corresponding to a document such as a book by imaging the document has been proposed (see, for example, JP 2017-182647 A). This method is used for, for example, a wearable glass and the like, and the acquired annotation is displayed on a display of the wearable glass.

By referring to the annotation displayed in this way, a user can easily grasp contents of the document. Here, in JP 2017-182647 A, an annotation is added as virtual reality on an actual book. For example, in a case where the annotation is a marker, an image of the marker is displayed on the contents in the book so as to be recognized as virtual reality. In a case where the annotation is a bookmark, on a page including a character to which the annotation is added, an image of the bookmark is displayed in an upper right blank portion in which no character is printed, so as to be recognized as virtual reality. Also in a case where the annotation is a memo, an image of the memo is displayed at a predetermined blank position so as to be recognized as virtual reality. However, in a case where an information amount of the annotation is large, the annotation may no longer be displayed in a blank In such a case, the annotation has to be superimposed on the contents in order to display the information. However, in this case, the annotation hides the contents of the book, which impairs the readability of the original book itself.

### SUMMARY

The present invention has been made in view of the above circumstances, and an object thereof is to provide an image information processing apparatus, electronic equipment, and an image information processing program capable of displaying an annotation to allow a user to visually recognize both contents and the annotation without impairment of the contents of recorded matter such as a book.

To achieve the abovementioned object, according to an aspect of the present invention, an image information processing apparatus reflecting one aspect of the present invention comprises: a hardware processor that: specifies, based on image information of an image captured by an imaging part, a document region in which a document that is visually recognizable recorded matter is arranged, the document region being a region included in the image; acquires an annotation corresponding to the document; and causes the annotation to be displayed in a region corresponding to a non-document region in a display region of a display, the non-document region being a region other than the document region in the image

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating a schematic configuration of a wearable glass according to a first embodiment;

FIG. 2 is a plan view illustrating an example of an image captured by an imaging part illustrated in FIG. 1;

FIG. 3 is a plan view illustrating an example of an annotation displayed on a display illustrated in FIG. 1;

FIG. 4 is a plan view illustrating another example of the annotation displayed on the display illustrated in FIG. 1;

FIG. 5 is a plan view illustrating even another example of the annotation displayed on the display illustrated in FIG. 1;

FIG. 6 is a block diagram illustrating a schematic configuration of a controller illustrated in FIG. 1;

FIG. 7 is a block diagram illustrating a functional configuration of a CPU illustrated in FIG. 6;

FIG. 8 is a flowchart illustrating processing of the controller illustrated in FIG. 6;

FIG. 9 is a subroutine flowchart illustrating an example of processing of step S102 illustrated in FIG. 8;

FIG. 10 is a plan view for explaining processing of step S201 illustrated in FIG. 9;

FIG. 11 is a subroutine flowchart illustrating an example of processing of step S104 illustrated in FIG. 8;

FIG. 12 is a subroutine flowchart illustrating an example of processing of step S105 illustrated in FIG. 8;

FIG. 13 is a plan view for explaining processing of step S402 illustrated in FIG. 12;

FIG. 14 is a table for explaining processing of step S406 illustrated in FIG. 12;

FIG. 15 is a subroutine flowchart illustrating an example of processing of step S106 illustrated in FIG. 8;

FIG. 16 is a subroutine flowchart illustrating an example of processing of step S107 illustrated in FIG. 8;

FIG. 17 is a plan view illustrating an annotation displayed on a display of a wearable glass according to a comparative example;

FIG. 18 is a plan view illustrating an example of an annotation displayed on the display illustrated in FIG. 1;

FIG. 19 is a view illustrating a schematic configuration of a tablet terminal according to a second embodiment;

FIG. 20 is a view illustrating a schematic configuration of a projector according to a third embodiment;

FIG. 21 is a plan view illustrating an example of arrangement of an annotation; and

FIG. 22 is a plan view illustrating another example of arrangement of the annotation.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same elements are denoted by the same reference numerals, and redundant descriptions are omitted. Further, the dimensional ratios in the drawings are exaggerated for convenience of description, and may differ from the actual ratios.

### First Embodiment

### Configuration of Wearable Glass

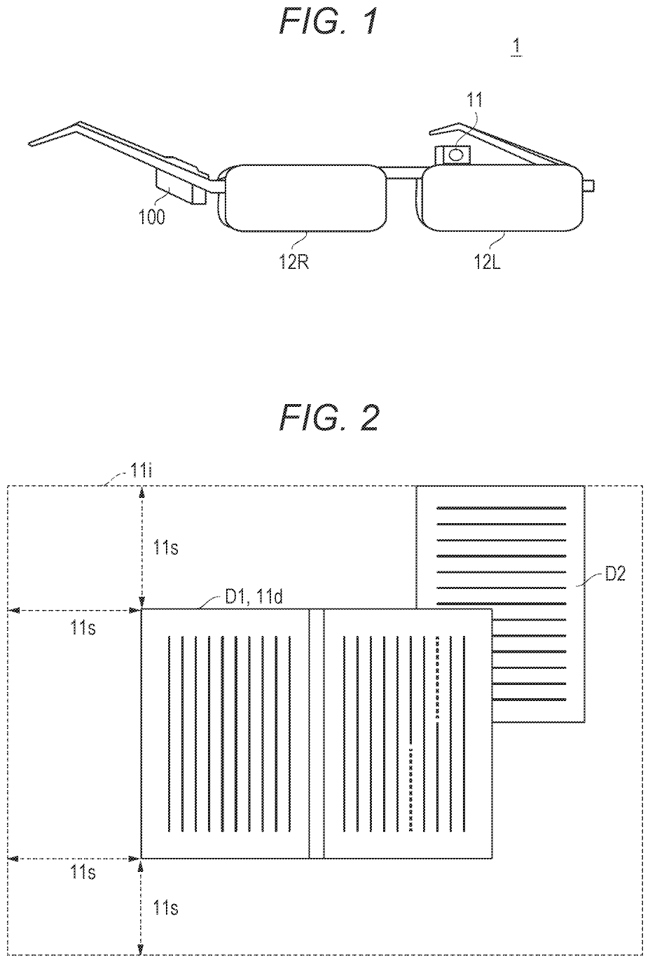

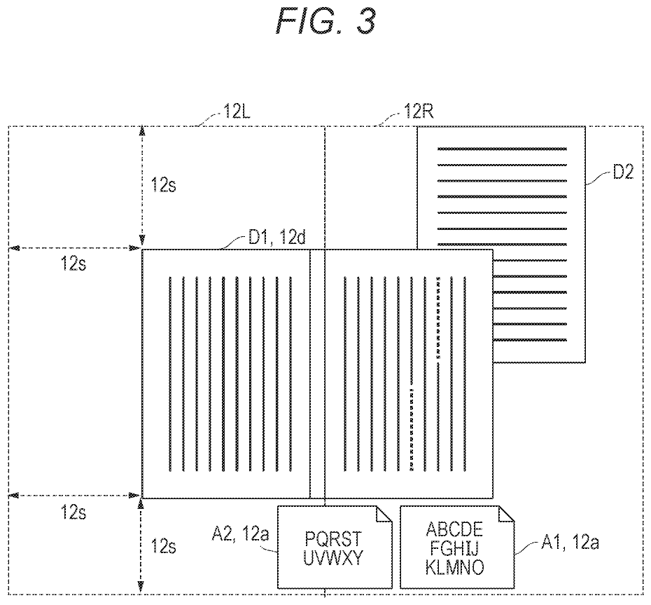

FIG. 1 illustrates a schematic configuration of a wearable glass 1 according to a first embodiment. The wearable glass 1 is a spectacle-type wearable computer, and includes an imaging part 11, displays 12R and 12L, and a controller 100. That is, in the wearable glass 1, the imaging part 11 is provided integrally with the display 12. A user visually recognizes an actual book or the like (for example, documents D1 and D2 in FIG. 3 to be described later) through the displays 12R and 12L, and visually recognizes an annotation (for example, annotations A1 and A2 to be described later) displayed on the displays 12R and 12L. Here, the controller 100 corresponds to a specific example of an image information processing apparatus according to the present invention, and the wearable glass 1 corresponds to a specific example of electronic equipment according to the present invention.

### Imaging Part

The imaging part 11 includes a lens. The lens of the imaging part 11 is arranged in the vicinity of the displays 12R and 12L so as to be substantially parallel to a line-of-sight direction of the user, and the imaging part 11 captures an image of an inside of a front visual field of the user. That is, the image captured by the imaging part 11 is an image obtained by capturing an image of a range visually recognizable by the user via the displays 12R and 12L. The imaging part 11 captures, for example, an image (for example, an image 11i including the documents D1 and D2 in FIG. 2 to be described later) including a document such as a book. Image information of the image captured by the imaging part 11 is sent to the controller 100. This image information includes, for example, character information regarding a character in the image, margin information regarding a margin in the image, position information regarding a position of at least one of a character or a margin in the image, color information regarding a color in the image, density information regarding a color density in the image, and the like.

FIG. 2 illustrates an example of an image (image 11i) captured by the imaging part 11. The image 11i is an image obtained by capturing an image of the documents D1 and D2 and a periphery thereof, by the imaging part 11. The document D1 is arranged at a center of the image 11i, and the document D2 is arranged at an upper right portion of the image 11i. Here, an annotation is to be added to the document D1. The image 11i is provided with a document region 11d in which the document D1 is arranged and a non-document region 11s other than the document region 11d.

The documents D1 and D2 according to the present embodiment refer to recorded matter that is visually recognizable by the user on a medium (media) such as a book, a document, a photograph, a picture, or the like. The documents D1 and D2 may be printed matter or non-printed matter.

### Display

The displays 12R and 12L are formed by a transparent material that transmits light. The transparent material forming the displays 12R and 12L is, for example, glass, a resin material, or the like. When the user wears the wearable glass 1, the display 12R is arranged to face the right eye of the user, and the display 12L is arranged to face the left eye of the user. For example, an annotation corresponding to the image 11i, specifically, an annotation (annotation A1 and A2 in FIGS. 3 to 5 to be described later) corresponding to the document D1 is displayed on the displays 12R and 12L.

The annotation is additional information associated with the document D1, and is specifically a marker, a memo, a bookmark, a translation, an additional description, a search result, or the like. Data related to the annotation is stored in the controller 100, for example. Data related to the annotation may be acquired from the outside via a network.

FIGS. 3 to 5 illustrate examples of the annotations A1 and A2 displayed on the displays 12R and 12L. In FIGS. 3 to 5, an actual scene visually recognized by the user wearing the wearable glass 1 via the displays 12R and 12L is superimposed with the annotations A1 and A2. That is, FIGS. 3 to 5 illustrate a field of view of the user wearing the wearable glass 1. The actual scene visually recognized by the user through the displays 12R and 12L is substantially the same as the image 11i, and the user visually recognizes the actual document D1 via a document region 12d of the displays 12R and 12L, and visually recognizes a periphery of the document D1 via a non-document region 12s. In other words, the document region 12d in the display region of the displays 12R and 12L corresponds to the document region 11d of the image 11i, while the non-document region 12s in the display region of the display 12 corresponds to the non-document region 11s of the image 11i.

In the present embodiment, the annotations A1 and A2 are displayed in the non-document region 12s in the display region of the displays 12R and 12L. More specifically, the annotations A1 and A2 are displayed in an annotation region 12a that is a part of the non-document region 12s. Therefore, in the wearable glass 1, the annotations A1 and A2 can be displayed at positions not overlapping the document D1 visually recognized by the user, in the display region of the displays 12R and 12L. Processing performed by the wearable glass 1 to display the annotations A1 and A2 in this manner will be described later.

For example, the annotation region 12a is provided at a position not overlapping with both the document D1 and the document D2 visually recognized by the user (FIG. 3). The annotations A1 and A2 are displayed in the annotation region 12a in, for example, a black character color and a white background color.

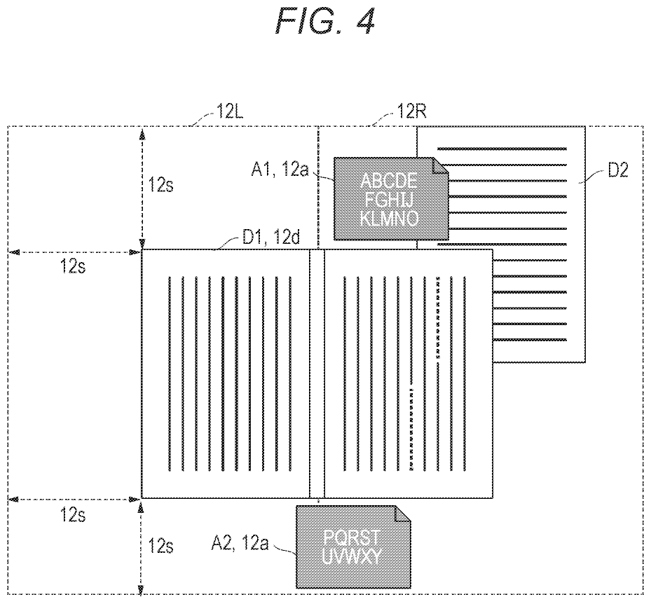

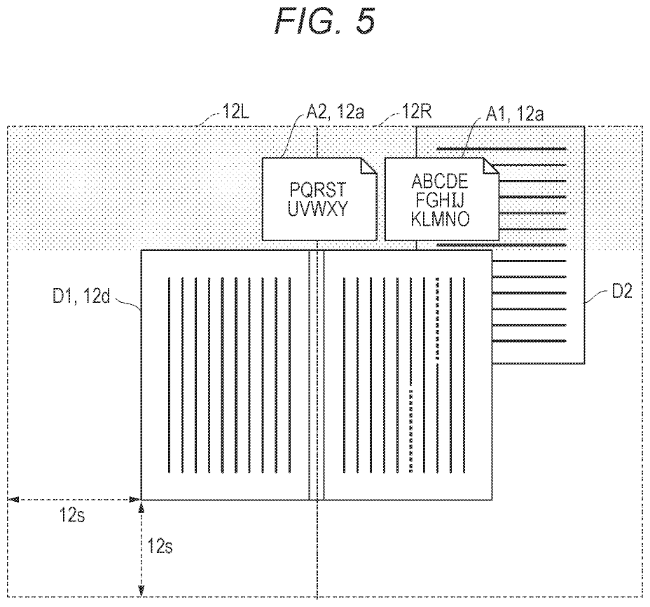

The annotation region 12a may be provided at a position overlapping with the document D2 visually recognized by the user (FIGS. 4 and 5). At this time, for example, the annotations A1 and A2 are displayed in a white character color and a black background color (FIG. 4). Alternatively, the annotations A1 and A2 of the black character color and the white background color may be displayed in the colored annotation region 12a (FIG. 5).

### Controller

The controller 100 controls the imaging part 11 and the display 12. For example, the controller 100 causes the imaging part 11 to capture the image 11i and causes the display 12 to display the annotations A1 and A2 based on image information of the image 11i.

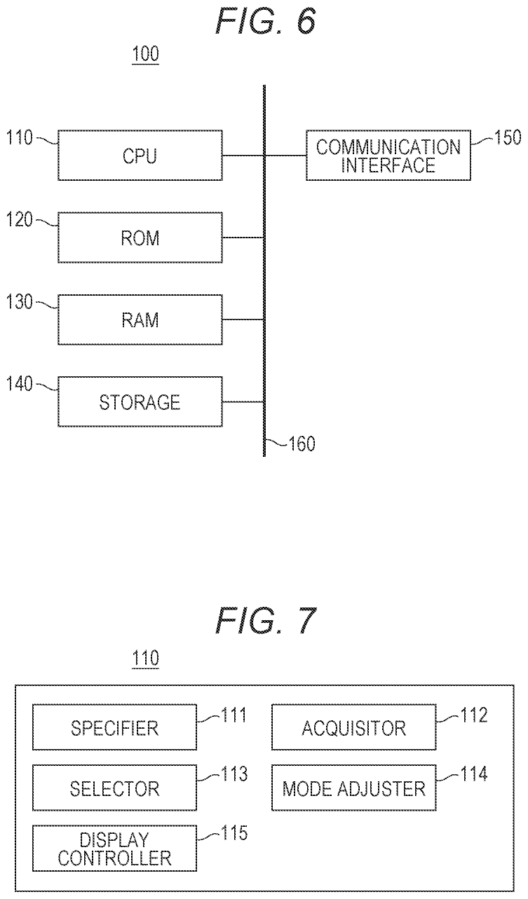

FIG. 6 is a block diagram illustrating a schematic configuration of the controller 100. The controller 100 includes a central processing unit (CPU) 110, a read only memory (ROM) 120, a random access memory (RAM) 130, a storage 140, and a communication interface 150. The individual configurations are communicably connected to each other via a bus 160.

The CPU 110 performs control of each of the above-described configurations and various types of arithmetic processing in accordance with a program recorded in the ROM 120 or the storage 140. A specific function of the CPU 110 will be described later. The ROM 120 stores various programs and various data. The RAM 130 temporarily stores programs and data, as a work area.

The storage 140 stores various programs including an operating system, and various data. For example, in the storage 140, an application is installed to transmit and receive various types of information to and from another device, and to determine information to be outputted on the basis of various types of information acquired from another device. In addition, the storage 140 stores information necessary for determining a candidate of information to be outputted. Note that, in a case where a machine learning model is used to determine information to be outputted, teacher data or a learned model necessary for machine learning may be stored.

The communication interface 150 is an interface for communication with other devices. As the communication interface 150, a communication interface according to various wired or wireless standards is used.

FIG. 7 is a block diagram illustrating an example of a functional configuration of the CPU 110. In the controller 100, for example, the CPU 110 functions as a specifier 111, an acquisitor 112, a selector 113, a mode adjuster 114, and a display controller 115, by reading a program stored in the storage 140 and executes processing.

The specifier 111 specifies a document region in which a document to be added with an annotation is arranged in an image, on the basis of image information of the image captured by the imaging part 11. For example, the specifier 111 specifies the document region 11d in which the document D1 is arranged in the image 11i (FIG. 2).

The acquisitor 112 acquires the annotation on the basis of image information of the image, specifically, on the basis of information included in the document region specified by the specifier 111. For example, the acquisitor 112 acquires the annotations A1 and A2 on the basis of information included in the document region 11d of the image 11i (FIGS. 2 to 5). The information included in the document region 11d is, for example, a title of the document D1 or information corresponding to the title.

The selector 113 selects an annotation region suitable for displaying the annotation from a region other than the document region of the image, that is, a non-document region. For example, the selector 113 selects an annotation region (for example, above or below the document region 11d in FIG. 2) suitable for displaying the annotations A1 and A2, from the non-document region 11s of the image 11i.

The mode adjuster 114 adjusts a mode of an annotation to be outputted to the display controller 115, on the basis of image information of the annotation region selected by the selector 113. Specifically, the mode adjuster 114 determines a character color, a background color, and the like of the annotation. For example, the mode adjuster 114 determines a character color and a background color of the annotations A1 and A2 displayed on the displays 12R and 12L. The mode adjuster 114 may determine one of the character color or the background color of the annotation.

The mode adjuster 114 may adjust a mode of an annotation region to be outputted to the display controller 115. Specifically, the mode adjuster 114 determines the necessity of coloring, a color tone of the coloring, and the like of the annotation region to be outputted to the display controller 115. For example, the mode adjuster 114 determines the necessity of coloring, a color tone of the coloring, and the like of the annotation region 12a displayed on the displays 12R and 12L.

The display controller 115 outputs the annotation to regions of the displays 12R and 12L corresponding to the annotation region selected by the selector 113, that is, the annotation regions of the displays 12R and 12L. At this time, the display controller 115 outputs the annotation in a mode adjusted by the mode adjuster 114. For example, the display controller 115 outputs the annotations A1 and A2 with the character color, the background color, and the like determined by the mode adjuster 114, onto the annotation regions 12a of the displays 12R and 12L.

### Processing by Controller

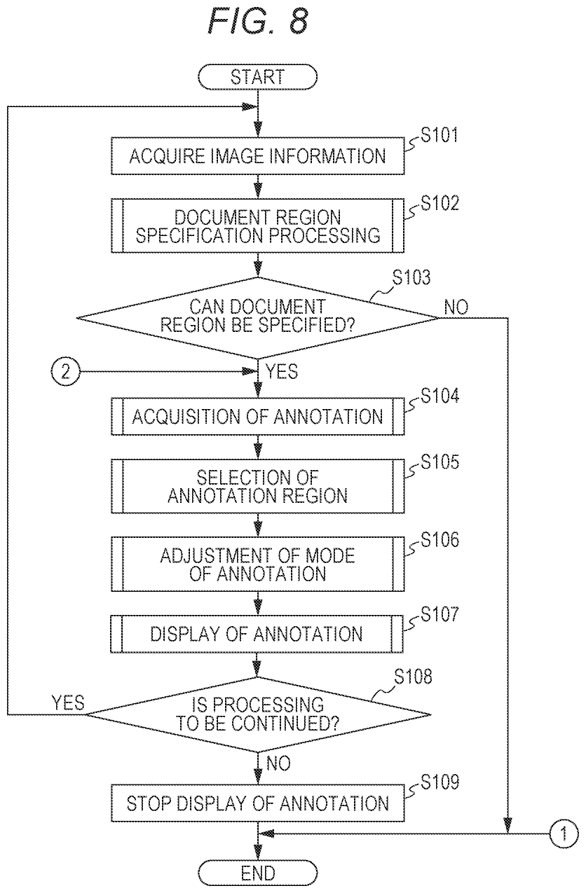

FIG. 8 is a flowchart illustrating a procedure of processing executed in the controller 100, that is, an image information processing method by the controller 100. The image processing method by the controller 100 is stored as a program in the storage 140 of the controller 100, for example, and is executed by the CPU 110 controlling each part.

First, the controller 100 causes the imaging part 11 to capture an image, to acquire image information of the image (step S101). Next, the controller 100 performs processing of specifying a document region in the image on the basis of the image information of the image (step S102), and determines whether or not the document region can be specified (step S103).

When the document region is not able to be specified (step S103: NO), the controller 100 ends the processing. When the document region can be specified (step S103: YES), the controller 100 acquires an annotation corresponding to a document on the basis of image information of the specified document region (step S104).

After acquiring the annotation corresponding to the document, the controller 100 selects an annotation region suitable for displaying the annotation from a non-document region other than the document region specified in step S102 (step S105).

Next, the controller 100 adjusts a mode of the annotation to be displayed on the displays 12R and 12L, on the basis of image information of the selected annotation region (step S106). Thereafter, the controller 100 outputs the annotation in the adjusted mode, and displays this annotation in the annotation region in the display region of the displays 12R and 12L (step S107).

Subsequently, the controller 100 determines whether or not to continue the processing (step S108). The controller 100 returns to the processing of step S101 when continuing the processing (step S108: YES), and ends the processing when not continuing the processing (step S108: NO).

Hereinafter, an example of each piece of processing of steps S102 to S107 will be described.

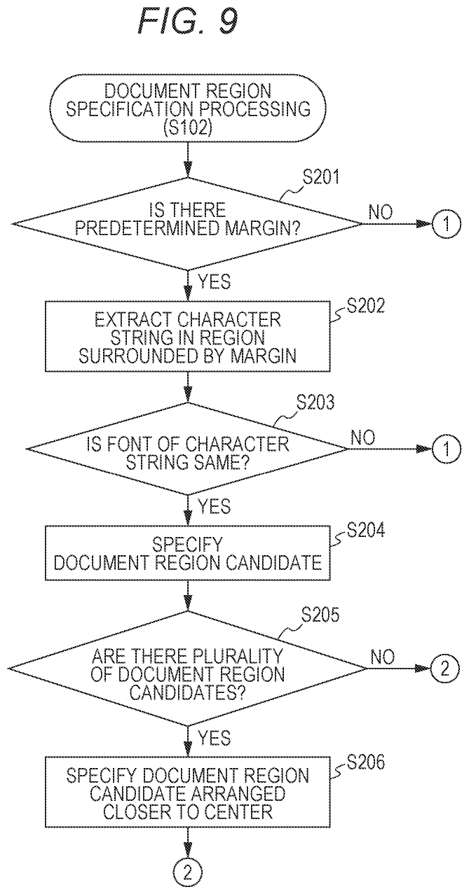

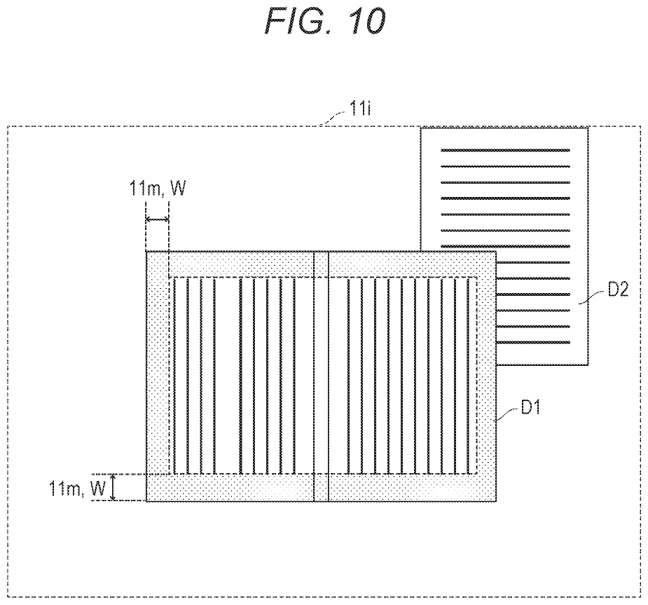

The processing of step S102 will be described with reference to FIGS. 9 and 10.

FIG. 9 is a flowchart illustrating an example of a subroutine of step S102. First, the controller 100 determines whether or not there is a predetermined margin in an image on the basis of margin information regarding a margin in the image (step S201). The predetermined margin is, for example, a margin having a size equal to or larger than a prescribed width and having a frame shape. When there is no predetermined margin (step S201: NO), the controller 100 determines that the document region is not able to be specified (step S103: NO). When there is a predetermined margin in the image (step S201: YES), the controller 100 then extracts a character string in a region surrounded by the margin (step S202).

FIG. 10 illustrates a margin 11m detected in the image 11i by the controller 100. The margin 11m has, for example, a rectangular frame shape having a width W. For example, when such a margin 11m is detected, the controller 100 determines that there is the predetermined margin in the image 11i (step S201: YES), and extracts a character string in a region surrounded by the margin 11m (step S202).

Subsequently, on the basis of character information regarding characters in the image in the region surrounded by the predetermined margin (for example, the margin 11m), the controller 100 determines whether or not a font of the character string in this region is the same (step S203). When the font of the character string in the region surrounded by the predetermined margin is not the same (step S203: NO), the controller 100 determines that the document region is not able to be specified (step S103: NO). When the font of the character string in the region surrounded by the predetermined margin is the same (step S203: YES), the controller 100 specifies a document region candidate (step S204). In step S203, the controller 100 may determine whether or not the font of the character string in the region surrounded by the predetermined margin is similar.

After specifying the document region candidate (step S204), the controller 100 specifies whether or not there are a plurality of document region candidates in the image (step S205). When there are not a plurality of document region candidates in the image (step S205: NO), the controller 100 specifies the document region candidate as it is as the document region (step S103: YES). When there are a plurality of document region candidates in the image (step S205: YES), the controller 100 specifies one document region candidate arranged at a position closer to a center on the basis of position information of each of the document region candidates (for example, a margin and a character of each document region candidate) (step S206). The controller 100 specifies the one document region candidate as the document region (step S103: YES).

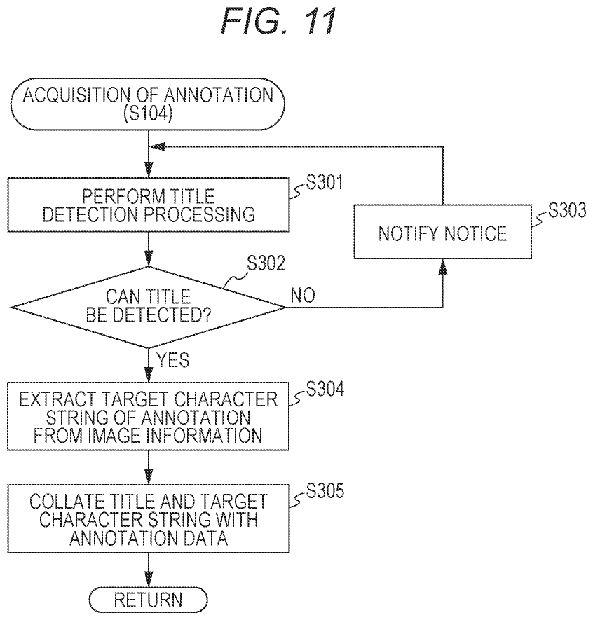

FIG. 11 is a flowchart illustrating an example of a subroutine of step S104.

First, the controller 100 performs processing of detecting a title of a document on the basis of the image information of the document region specified in step S102 (step S301), and determines whether or not the title of the document can be detected (step S302). For example, the controller 100 performs the processing of detecting the title of the document on the basis of character information included in the image information. For the processing of detecting the title of the document, a known character extraction technique can be used. Alternatively, the controller 100 may perform the processing of detecting the title of the document on the basis of code information such as an international standard book number (ISBN).

When the title of the document is not able to be detected (step S302: NO), the controller 100 notifies the user of a notice that the title of the document is not able to be detected (step S303), and then performs the processing of step S301 again. In step S303, the controller 100 may notify the user that the ISBN, a cover of the document, or the like needs to be photographed.

When the title of the document can be detected (step S302: YES), the controller 100 extracts a target character string to which the annotation is to be added, on the basis of the image information of the document region (step S304). For extracting the target character string, a known character extraction technique can be used. Furthermore, in order to increase the efficiency of the extraction processing, a character string to which a line or a marker is attached or a character string including a position indicated by the user's fingertip can be extracted as an option. Next, the controller 100 collates the detected title and the extracted target character string with annotation data stored in the storage 140 or the like (step S305). This allows an annotation corresponding to the document to be acquired. For example, a position of a character string or a paragraph described in an opened page is collated with contents of a database (DB) to acquire a range of an imaged range in the document, and the annotation is acquired by calling an annotation stored in advance in association with a character string in the range.

The processing of step S105 will be described with reference to FIGS. 9 to 14.

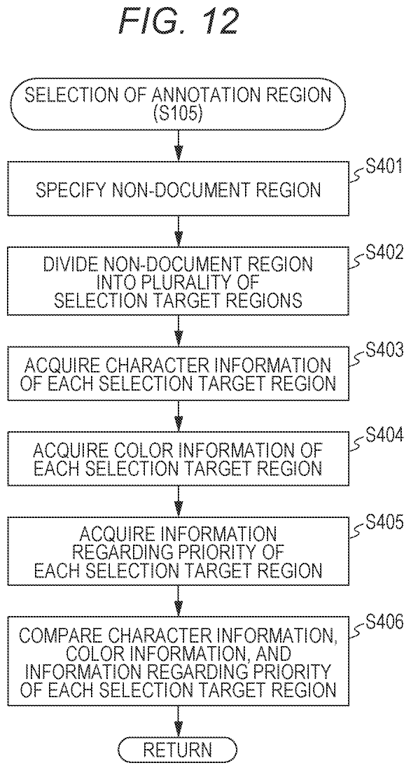

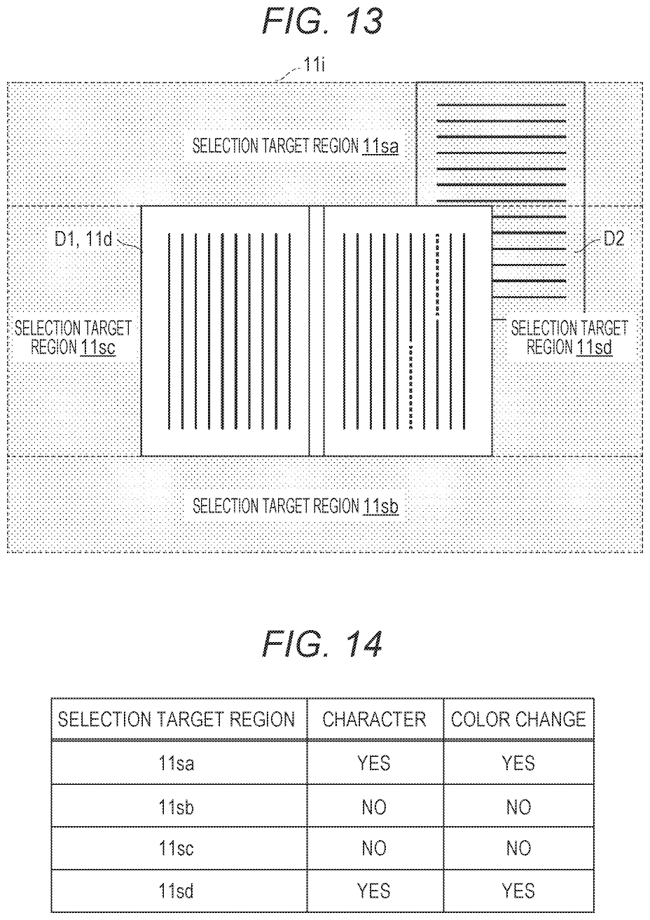

FIG. 12 is a flowchart illustrating an example of a subroutine of step S105. First, the controller 100 specifies a non-document region in an image (step S401). The non-document region is a region in the image other than the document region specified in step S102. Next, the controller 100 divides the specified non-document region into a plurality of selection target regions (selection target regions 11sa to 11sd in FIG. 13 to be described later) (step S402).

FIG. 13 illustrates an example of the selection target regions 11sa, 11sb, 11sc, and 11sd of the image 11i. Here, the non-document region 11s of the image 11i is divided into the four selection target regions (selection target region 11sa, 11sb, 11sc, and 11sd). The selection target region 11sa is provided above the document region 11d, the selection target region 11sb is provided below the document region 11d, the selection target region 11sc is provided in on the left of the document region 11d, and the selection target region 11sd is provided on the right of the document region 11d, individually.

After dividing the non-document region 11s into a plurality of selection target regions, the controller 100 acquires character information of each selection target region (step S403). In step S403, for example, the controller 100 acquires information regarding the presence or absence of a character in each selection target region. This allows, for example, the annotation to be displayed in a region where there is no character, to enhance the visibility of the annotation.

Next, the controller 100 acquires color information regarding a color of each selection target region (step S404). In step S404, for example, the controller 100 acquires information regarding magnitude of a color change in each selection target region. By acquiring the information regarding the magnitude of the color change, for example, an arrangement situation of objects around the document D1 can be estimated, and complexity of each selection target region can be estimated. This allows, for example, the annotation to be displayed in a region where the color change falls within a predetermined range, to enhance the visibility of the annotation. For example, the annotation is preferably displayed in a region where there is no object, that is, a region where there is no color change. The information regarding the magnitude of the color change in each selection target region can be acquired using a known image processing technique, and can be acquired using a technique such as edge extraction, for example.

In step S404, the controller 100 may acquire density information regarding a color density of each selection target region together with or instead of the color information of each selection target region. The controller 100 may acquire information regarding brightness of each selection target region instead of acquiring color information or density information of each selection target region. This allows, for example, the annotation to be displayed in a region where a change in density or a change in brightness is within a predetermined range, to enhance the visibility of the annotation.

Next, the controller 100 acquires information regarding priority of each selection target region (step S405). The information regarding the priority of each selection target region is, for example, information regarding a priority order for selection as the annotation region. The priority order of the selection target region to be selected as the annotation region is set by the user from the viewpoint of, for example, the visibility of the annotation.

The controller 100 may acquire the character information, the color information, and the information regarding the priority of each selection target region in an order other than the above.

After acquiring the character information, the color information, and the information regarding the priority of each selection target region, the controller 100 compares the character information, the color information, and the information regarding the priority of each selection target region (step S406), and selects the annotation region.

FIG. 14 illustrates information regarding character information and color information of each of the selection target regions 11sa, 11sb, 11sc, and 11sd illustrated in FIG. 13. In the selection target region 11sa, there is a character, and a color change is observed. In the selection target region 11sb, there is no character, and no color change is observed. In the selection target region 11sc, there is no character, and no color change is observed. In the selection target region 11sd, there is a character, and a color change is observed. That is, in the selection target region 11sb and the selection target region 11sc, there is no character, and no color change is observed. In addition, for example, priority according to a position may be set for the selection target regions 11sa, 11sb, 11sc, and 11sd, and this priority may be stored in advance in the wearable glass 1 or the like. The priority according to the position is set on the basis of, for example, a direction of a character string, a layout pattern, or the like of a document (more specifically, contents in the document). For example, in the vertical writing document D1 illustrated in FIG. 13, priority of an upper position (selection target region 11sa) of the contents in the document D1 is the highest, while the priority becomes lower in an order of a lower position (selection target region 11sb), a left position (selection target region 11sc), and a right position (selection target region 11sd). On the basis of these pieces of information, the controller 100 selects the selection target region 11sb having higher priority as the annotation region, for example, among the selection target region 11sb and the selection target region 11sc in which there is no character and no color change is observed. As described above, by the controller 100 selecting the annotation region from the non-document region 11s (selection target region 11sa, 11sb, 11sc, and 11sd) on the basis of the plurality of pieces of information, the visibility of the annotation can be further enhanced.

Alternatively, the controller 100 may select the annotation region on the basis of any one of the character information, the color information, and the information regarding the priority. For example, the controller 100 may select the selection target region 11sa having the highest priority among the selection target regions 11sa, 11sb, 11sc, and 11sd, as the annotation region.

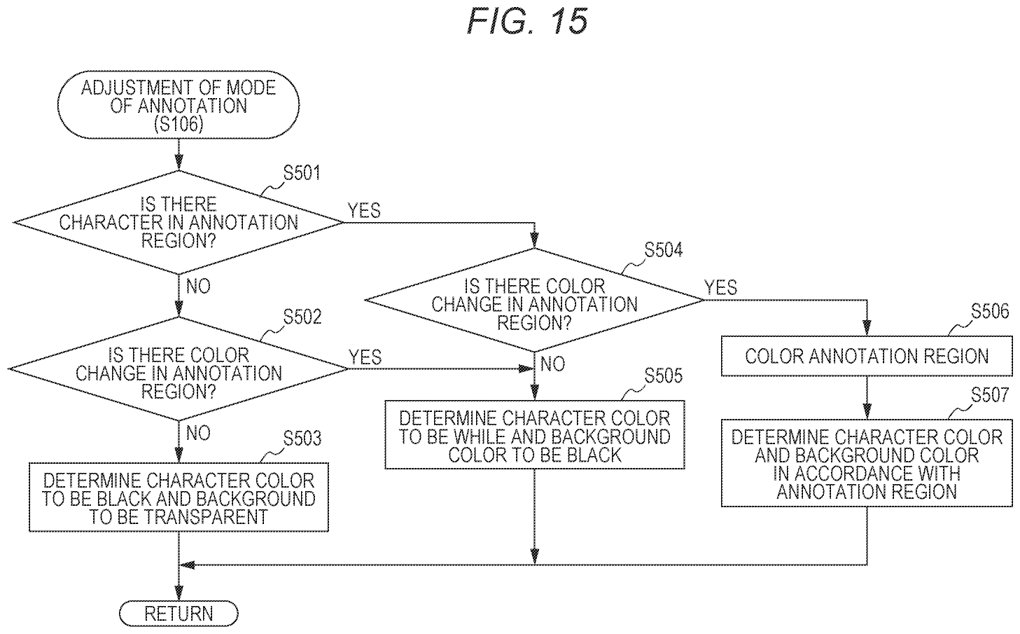

FIG. 15 is a flowchart illustrating an example of a subroutine of step S106.

First, the controller 100 determines whether or not there is a character in the selected annotation region (step S501), and whether or not there is a color change (steps S502 and S504).

When there is no character in the selected annotation region (step S501: NO) and no color change is observed (step S502: NO), the controller 100 determines the character color to be black and the background to be transparent in the annotation to be displayed on the displays 12R and 12L (step S503) (see FIG. 3).

When there is no character in the selected annotation region (step S501: NO), and a color change is observed (step S502: YES), the controller 100 determines the character color to be white and the background color to be black in the annotation to be displayed on the displays 12R and 12L (step S505) (see FIG. 4). Also when there is a character in the selected annotation region (step S501: YES), and a color change is not observed (step S504: NO), the controller 100 determines the character color to be white and the background color to be black in the annotation to be displayed on the displays 12R and 12L (step S505).

When there is a character in the selected annotation region (step S501: YES), and a color change is observed (step S502: YES), the controller 100 colors the annotation region to be displayed on the displays 12R and 12L (step S506). Thereafter, the controller 100 determines the character color and the background color of the annotation in accordance with the colored annotation region (step S507) (see FIG. 5).

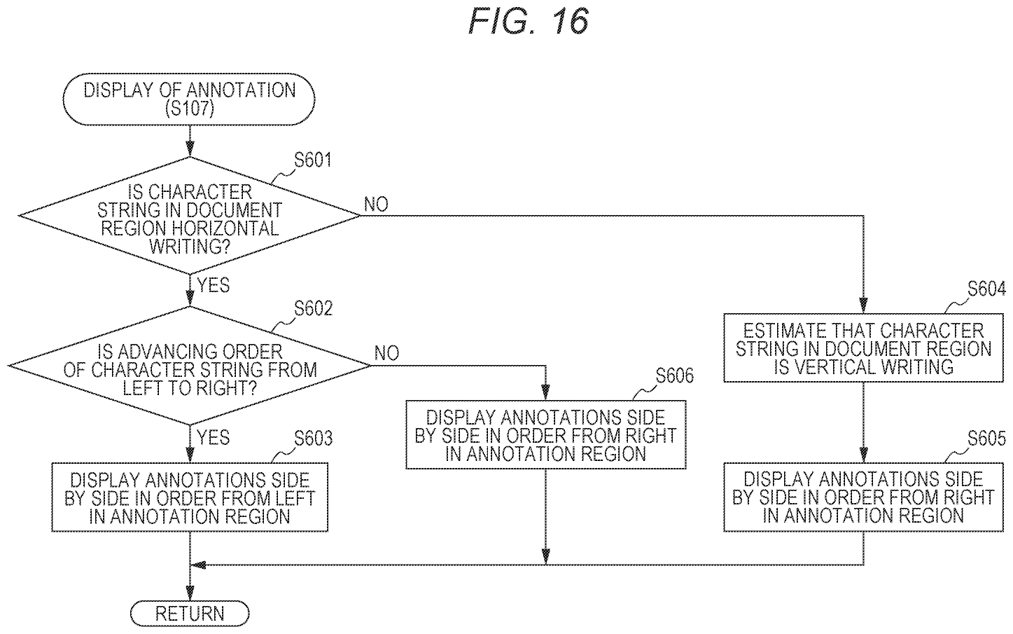

FIG. 16 is a flowchart illustrating an example of a subroutine of step S107.

First, the controller 100 determines whether or not the character string in the document region is horizontal writing, on the basis of the image information of the document region (step S601). When the character string in the document region is not horizontal writing (step S601: NO), the controller 100 estimates that the character string in the document region is vertical writing (step S604), and displays the annotations side by side in order from the right in the annotation regions of the displays 12R and 12L (step S605).

When the character string in the document region is horizontal writing (step S601: YES), the controller 100 determines whether or not an advancing order of the character string is from left to right (step S602). When the advancing order of the character string is from left to right (step S602: YES), the controller 100 displays the annotations side by side in order from the left in the annotation regions of the displays 12R and 12L (step S603). When the advancing order of the character string is not from left to right (step S602: NO), the controller 100 displays the annotations side by side in order from the right in the annotation regions of the displays 12R and 12L (step S606).

### Working Effect of Wearable Glass

In the wearable glass 1 of the present embodiment, the annotation is displayed in the non-document region in the display region of the display 12, corresponding to the non-document region of the image. Therefore, it is possible to display the annotation at a position not overlapping with the document to which the annotation is to be added. Hereinafter, this working effect will be described in detail.

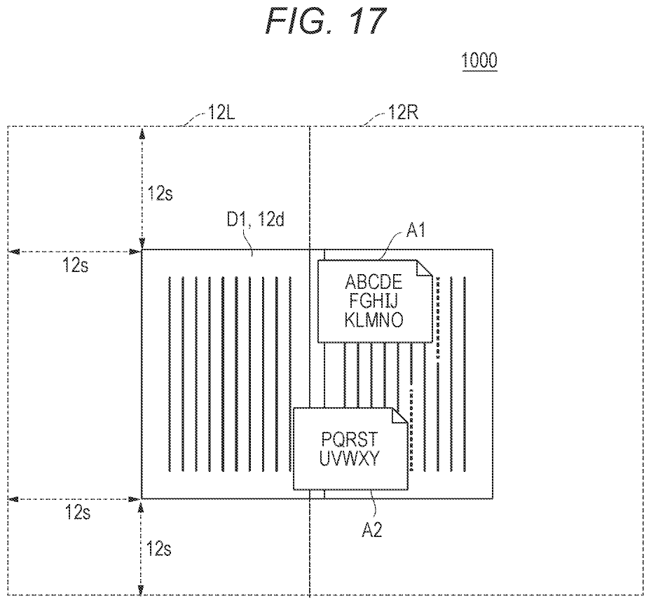

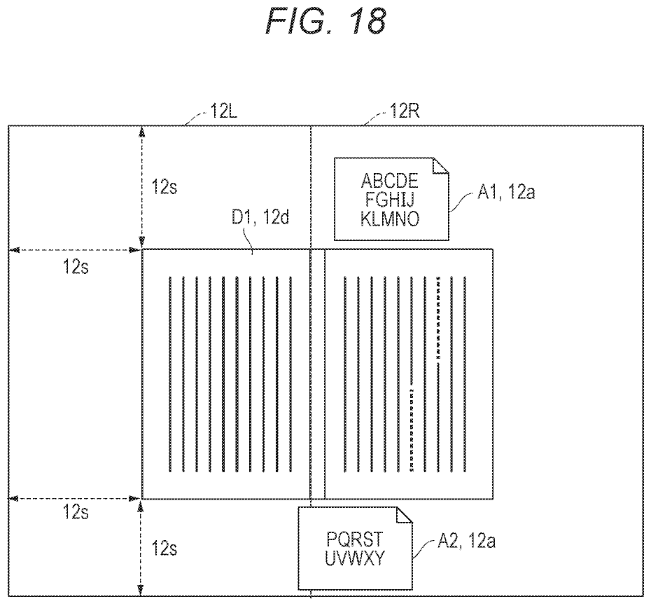

FIG. 17 illustrates displays 12R and 12L of a wearable glass 1000 according to a comparative example, and FIG. 18 illustrates the displays 12R and 12L of the wearable glass 1 according to the present embodiment. A user wearing the wearable glass 1 or 1000 visually recognizes the actual document D1 through the document region 12d of the displays 12R and 12L, together with the annotations A1 and A2 displayed on the displays 12R and 12L.

In the wearable glass 1000 according to the comparative example, there is a possibility that a document region in which the document D1 is arranged is not specified in the captured image, and the annotations A1 and A2 are displayed at positions overlapping with the document region 12d of the displays 12R and 12L, that is, at positions overlapping with the document D1. The annotations A1 and A2 displayed at positions overlapping with the document D1 deteriorate readability of the document D1.

On the other hand, in the wearable glass 1, since the document region of the image is specified by the controller 100, the annotations A1 and A2 are displayed in the non-document region 12s in the display region of the display 12, corresponding to the non-document region of the image. That is, since the annotations A1 and A2 are displayed at positions not overlapping with the document D1, the annotations A1 and A2 can be displayed without impairment of the readability of the document D1.

Furthermore, in the wearable glass 1, the controller 100 selects an annotation region suitable for displaying the annotations A1 and A2 from the non-document region 11s. This makes it possible to enhance the visibility of the annotations A1 and A2 regardless of a surrounding environment of the document D1.

As illustrated in FIGS. 3, 4, and the like, the user wearing the wearable glass 1 visually recognizes, in addition to the annotations A1 and A2 displayed on the displays 12R and 12L, the actual document D1 and the document D2 near the document D1, via the displays 12R and 12L. In the non-document region 12s in the display region of the display 12, the annotations A1 and A2 may be displayed at positions overlapping with the document D2 (FIG. 4), or may be displayed at a position not overlapping the document D2 (FIG. 3).

Here, normally, by the controller 100 selecting an annotation region (for example, the selection target region 11sb in FIG. 13) that does not overlap with the document D2 from the non-document region 11s, the annotations A1 and A2 are displayed at positions not overlapping with the document D2 (FIG. 3). As a result, it is possible to also enhance the visibility of the contents of the documents D1 and D2, in addition to the visibility of the annotations A1 and A2.

Whereas, when a plurality of annotations are not able to be displayed side by side due to restriction of a display space, or the like, the controller 100 selects an annotation region (for example, the selection target region 11sa in FIG. 13) overlapping with the document D2, from the non-document region 11s. This allows, for example, the annotation A1 to be displayed at a position overlapping with the document D2 (FIG. 4). At this time, for example, by adjusting at least a mode of the annotation A1 to be displayed in superposition with the document D2 or a mode of the annotation region 12a for display, the visibility of the annotations A1 and A2 can be enhanced.

As described above, according to the wearable glass 1 of the present embodiment, the annotation is displayed in the non-document region in the display region of the displays 12R and 12L, corresponding to the non-document region in the image. This makes it possible to display the annotation at a position not overlapping with the document (document D1) to which the annotation is to be added. Therefore, the user wearing the wearable glass 1 can visually recognize both the contents and the annotation in the document, and can easily grasp the contents of the document.

In the first embodiment, the example in which the annotation is displayed in the wearable glass has been described, but the annotation may be displayed in another piece of electronic equipment. Hereinafter, in a second embodiment and a third embodiment, an example in which an annotation is outputted on another piece of electronic equipment will be described.

### Second Embodiment

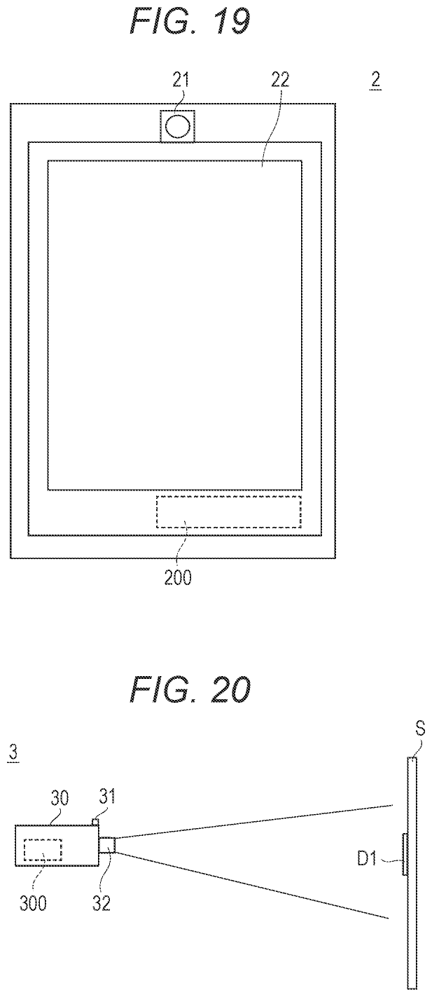

FIG. 19 illustrates a configuration of a tablet terminal 2 according to the second embodiment. The tablet terminal 2 includes an imaging part 21, a display 22, and a controller 200. That is, in the tablet terminal 2, the imaging part 21 is provided integrally with the display 22.

The imaging part 21 is arranged, for example, in the vicinity of the display 22, and has a function similar to that of the imaging part 11 of the wearable glass 1. Image information of an image captured by the imaging part 21 is sent to the controller 200.

The display 22 displays an image on the basis of image information of the image captured by the imaging part 21. In the display 22, an annotation is displayed together with this image The display 22 is, for example, a non-transmissive display that does not transmit light.

The controller 200 has a function similar to that of the controller 100 of the wearable glass 1. The controller 200 displays an image captured by the imaging part 21, specifies a document region of the image on the basis of the image information of the image captured by the imaging part 21, and synthesizes and displays an annotation in a non-document region in a display region of the display 22, corresponding to the non-document region of the image

In this manner, the annotation may be displayed together with the captured image. The annotation may be displayed on a display such as a smartphone.

### Third Embodiment

FIG. 20 illustrates a configuration of a projector 3 according to the third embodiment. The projector 3 includes a housing 30, an imaging part 31, a projection part 32, and a controller 300. That is, in the projector 3, the imaging part 31 is provided integrally with the projection part 32.

The imaging part 31 is disposed near the projection part 32 on the housing 30, for example. This imaging part 31 has a function similar to that of the imaging part 11 of the wearable glass 1. Image information of an image captured by the imaging part 31 is sent to the controller 300.

The projection part 32 projects and displays an annotation. The projected annotation is displayed on a projection target member such as a screen S, for example. The projection target member may be a desk or the like. For example, an actual document (for example, a document D1 in FIG. 20) to which an annotation is to be added is arranged on the projection target member, and the projection part 32 projects the annotation on the document. The projection part 32 may project the annotation together with the image captured by the imaging part 31.

The controller 300 has a function similar to that of the controller 100 of the wearable glass 1. The controller 300 specifies a document region of an image on the basis of image information of the image captured by the imaging part 31, and projects an annotation onto a non-document region in a display region on the projection target member, corresponding to a non-document region of the image.

In this manner, the annotation may be displayed by the projection part.

### Modification

The configurations of the wearable glass, the tablet terminal, and the projector described above have been described as main configurations in describing the features of the above embodiments, and various modifications can be made within the scope of the claims without limiting to the above configurations. In addition, configurations included in general wearable glasses, tablet terminals, and projectors are not excluded.

Furthermore, in the above embodiments, an example in which the wearable glass, the tablet terminal, and the projector include the imaging part has been described, but the imaging part may be provided outside the wearable glass, the tablet terminal, and the projector. These wearable glass, tablet terminal, and projector acquire image information of an image captured by an external imaging part via a communication interface, for example.

Furthermore, in the above embodiment, an example in which two annotations (annotation A1 and A2) are added to the document (document D1) has been described, but the number of annotations to be added to the document may be one or three or more.

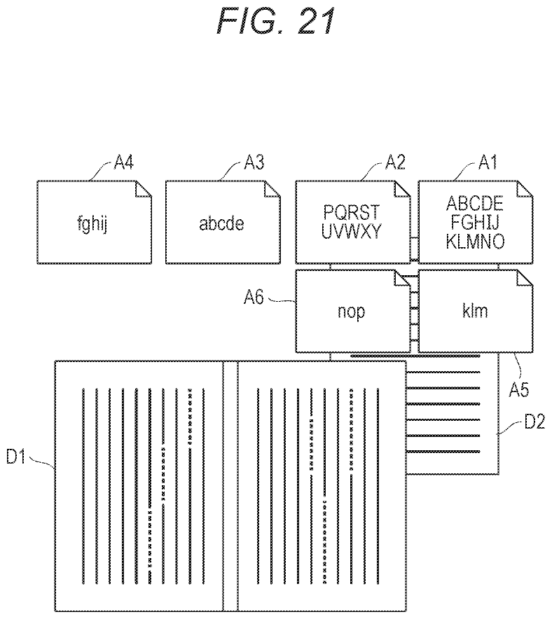

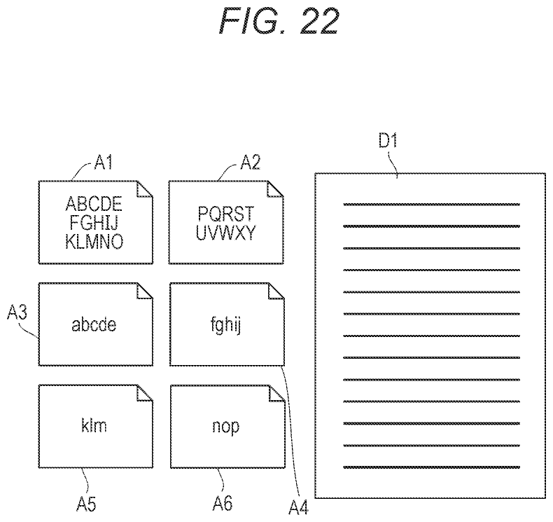

FIGS. 21 and 22 illustrate six annotations (annotation A1, A2, A3, A4, A5, and A6) added to the document D1.

In FIG. 21, the annotations A1 to A6 are outputted side by side in order from the right so as to correspond to the vertical writing document D1. For example, the annotations A1 to A4 are arranged side by side in order from the right, and the annotations A5 and A6 are arranged below the annotations A1 to A4 side by side in order from the right.

In FIG. 22, the annotations A1 to A6 are outputted side by side in order from the left so as to correspond to the document D1 in horizontal writing. For example, the annotations A1 and A2 are arranged side by side in order from the left, the annotations A3 and A4 are arranged side by side in order from the left below the annotations A1 and A2, and the annotations A5 and A6 are arranged side by side in order from the left below the annotations A3 and A4.

In this manner, the annotations A1 to A6 may be outputted side by side in two directions of left and right and up and down (FIGS. 21 and 22).

Furthermore, in the above embodiment, a case has been described where information regarding an annotation to be added to a document is stored in advance in the controller or the outside. However, the information regarding an annotation to be added to a document may be created on the basis of image information of a captured image. For example, the controller or an external device may create a Japanese translation on the basis of image information of an image obtained by capturing an image of an English document, and output the Japanese translation as an annotation.

Furthermore, in the above embodiment, the subroutine of each piece of processing of steps S102 to S107 of FIG. 8 has been described, but each piece of processing of steps S102 to S107 may be processing other than the above processing. For example, in the processing of step S106 (see FIG. 15), the character color and the background color of the annotation may be adjusted regardless of a state of the annotation region (presence or absence of a character, a color change, and the like).

Means and methods for performing various kinds of processing according to the above embodiments can be realized by either a dedicated hardware circuit or a programmed computer. The program may be provided by, for example, a computer-readable recording medium such as a flexible disk and a CD-ROM, or may be provided online via a network such as the Internet. In this case, the program recorded in the computer-readable recording medium is usually transferred to and stored in a storage part such as a hard disk. In addition, the program may be provided as independent application software, or may be incorporated into software of the device as one function of the system.

Although embodiments of the present invention have been described and illustrated in detail, the disclosed embodiments are made for purposes of illustration and example only and not limitation. The scope of the present invention should be interpreted by terms of the appended claims

What is claimed is:

1. An image information processing apparatus comprising:
a hardware processor that:
specifies, based on image information of an image captured by an imaging part, a document region in which a document that is visually recognizable recorded matter is arranged, the document region being a region included in the image;
acquires an annotation corresponding to the document; and
causes the annotation to be displayed in a region corresponding to a non-document region in a display region of a display, the non-document region being a region other than the document region in the image

2. The image information processing apparatus according to claim 1, wherein the hardware processor acquires the annotation based on information included in the document region in the image information.

3. The image information processing apparatus according to claim 2, wherein the information is a title of the document or information corresponding to the title.

4. The image information processing apparatus according to claim 1, wherein the hardware processor further selects, as an annotation region to display the annotation, a part of the non-document region from the non-document region.

5. The image information processing apparatus according to claim 4, wherein the hardware processor selects a region having no character in the non-document region as the annotation region, based on character information in the non-document region in the image information.

6. The image information processing apparatus according to claim 4, wherein the hardware processor selects, as the annotation region, a region having a color change within a predetermined range in the non-document region, based on color information in the non-document region in the image information.

7. The image information processing apparatus according to claim 4, wherein the hardware processor selects, as the annotation region, a region in which density or brightness is within a predetermined range in the non-document region, based on density information or brightness information of the non-document region in the image information.

8. The image information processing apparatus according to claim 4, wherein
the hardware processor further adjusts a mode of the annotation to be displayed on the display, based on the image information of the selected annotation region, and
the hardware processor causes the annotation to be displayed in a mode adjusted by the hardware processor.

9. The image information processing apparatus according to claim 8, wherein the hardware processor adjusts at least one of a character color or a background color of the annotation.

10. The image information processing apparatus according to claim 8, wherein
the hardware processor further adjusts a mode of a region corresponding to the annotation region, and
the hardware processor causes a region corresponding to the annotation region to be displayed in an adjusted mode.

11. The image information processing apparatus according to claim 1, wherein
the image information includes margin information regarding a margin in the image, and
the hardware processor specifies the document region based on the margin information.

12. The image information processing apparatus according to claim 11, wherein the hardware processor further specifies the document region based on a character in a region surrounded by the margin.

13. The image information processing apparatus according to claim 1, wherein
the image information includes position information regarding a position in the image, the position being of at least one of a character or a margin in the image, and
the hardware processor specifies the document region based on the position information.

14. The image information processing apparatus according to claim 1, wherein the hardware processor causes the annotation to be displayed on the display of a transmissive type that transmits light, the display being wearable by a user.

15. The image information processing apparatus according to claim 1, wherein the hardware processor causes the captured image to be displayed on the display of a non-transmissive type that does not transmit light, and the hardware processor causes the annotation to be synthesized and displayed on the display.

16. The image information processing apparatus according to claim 14, wherein the imaging part is provided integrally with the display.

17. The image information processing apparatus according to claim 1, wherein the hardware processor causes the annotation to be displayed by causing the annotation to be projected by a projection part that projects the document.

18. The image information processing apparatus according to claim 17, wherein the imaging part is provided integrally with the projection part.

19. Electronic equipment comprising:
the imaging part; and
the image information processing apparatus according to claim 1.

20. A non-transitory recording medium storing a computer readable image information processing program causing a computer to function as the image information processing apparatus according to claim 1.
